(19) United States
(12) Patent Application Publication
(10) Pub. No.: US 2002/0115436 A1
(43) Pub. Date: Aug. 22, 2002

(54) Telematics system

(76) Inventors: Robert M. Howell, Burlington, IA (US); Timothy J. Stevenson, Vista, CA (US)

Correspondence Address: The Law Offices of William W. Cochran, 3555 Stanford Road, Suite 230, Fort Collins, CO, 80525, US

(21) Appl. No.: 09/968,746

(22) Filed: Oct. 1, 2001

Related U.S. Application Data
(60) Provisional application No. 60/236,682, filed on Sep. 29, 2000.

(51) Int. Cl. H04M 3/42

(52) U.S. Cl. 455/426; 455/456; 455/404; 455/414

(57) ABSTRACT

Disclosed is a telematics system that is self-contained and includes a number of anti-defeat counter-measure features that prevent the disablement of the system. In addition, the present system utilizes event sensors, such as motion sensors, to detect the existence of an event after the remote unit has been armed. Location data is then sent to a base station that calculates if the unit has been moved beyond a predetermined perimeter which causes the generation of a alarm condition. The telematics system is also capable of adjusting the transmission frequency period of location data and prioritizing the data that is sent. Further, the system reduces the amount of location data that is sent from the remote unit by eliminating redundant data. Transmission rates of the data are maximized by adjusting the baud rate according to the signal strength of a communication link between the remote unit and a base station. The base station is capable of generating dead reckoning data from raw direction and speed data as well as GPS location data provided by the remote unit. Dual antennas are provided that minimize space requirements by placing both the GPS antenna and a cellular phone antenna on a single substrate, printed circuit board. An isolation fence is provided between the antennas to isolate the electromagnetic waves. Voltage supplies are also monitored by the remote unit to determine if an external power supply has been cut or if the vehicle battery is dead.

### CROSS-REFERENCE TO RELATED APPLICATIONS

The present invention is based upon and claims priority from U.S. Provisional Application Serial No. 60/236,682, filed Sep. 29, 2000, entitled “Communication System.”

### FIELD OF THE INVENTION

The present invention relates generally to a communication system and more particularly to a telematics system.

### BACKGROUND OF THE INVENTION

Communication systems have evolved where assets, such as people or property, can be monitored. Such communication systems typically have a remote unit, a base station, a cell phone transceiver and a global positioning system receiver and are referred to as telematics systems. The cellular communicator in the remote unit provides location and other information to a base station relating to the asset.

### SUMMARY OF INVENTION

The present invention provides a system that is self contained, includes anti-defeat counter-measure features, can provide location and other information upon occurrence of certain conditions without being polled by a base station, monitors power levels to determine if external power sources have been lost, changes the baud rate for sending data over a cellular link based upon signal strength of the cell link, transmits raw heading information and speed to a base unit for dead reckoning calculations when a cell link is lost, minimizes transmission time by eliminating only new portions of location data that have been generated by the remote unit and sends location information based on a period that is related to the speed of the remote unit.

The present invention may therefore comprise a method of generating an alarm condition in a telematics system comprising: transmitting location information from a remote unit to a base station after the remote unit has been armed and the remote unit has detected an event; determining if the remote unit has moved beyond a preprogrammed perimeter; generating an alarm condition whenever the remote unit has moved beyond the perimeter.

The invention may further comprise a method of adjusting the transmission frequency period of a remote unit in a telematics system comprising: determining the speed of movement of the remote unit; adjusting the transmission frequency period in response to the speed of movement of the remote unit so that the period is increased whenever the remote unit is moving at a lower speed and decreased whenever the remote unit is moving at a higher speed.

The invention may further comprise a method of decreasing the amount of data that is transmitted by a remote unit in a telematics device comprising: comparing data that has been previously transmitted by the remote unit with data to be transmitted by the remote unit; extracting data strings from the data to be transmitted that does not match data strings of the data that has previously been transmitted to generate extracted data strings; transmitting the extracted data strings.

The invention may further comprise a method of adjusting the data transmission rate of a cellular radio module in a remote unit of a telematics device and maintaining quality data transmissions comprising; detecting signal strength of a communication link between the cellular radio module and a base station; adjusting the data transmission rate of the cellular radio module based upon the signal strength.

The invention may further comprise a method of prioritizing the transmission data from a remote unit to a base station in a telematics device comprising: determining when a communication link is broken between the remote unit and the base station; storing location data while the communication link is broken; determining when the communication link has been re-established; transmitting current location data prior to stored location data.

The invention may further comprise a method of providing dead reckoning location information in a telematics device whenever a communication link between a remote unit and a base station is lost comprising: generating raw direction and speed data at a remote unit of the telematics device and GPS location data; transmitting the GPS location data and the raw direction and speed data from the remote unit to a base station; calculating location information at the base station using the GPS location data and the raw direction and speed data using dead reckoning techniques.

The invention may further comprise a method of providing dual antennas in a telematics device that minimize space requirements and provide isolation comprising: placing a GPS antenna on a first portion of a substrate having a first ground plane that is isolated from other ground planes in the telematics device; placing a cellular phone antenna on a second portion of the substrate having a second ground plane that is isolated from other ground planes in the telematics device and from the first ground plane; placing an isolation fence between the GPS antenna and the cellular phone antenna to isolate the GPS antenna and the cellular phone antenna.

The invention may further comprise a method of determining if external power has been lost to a telematics remote unit comprising: monitoring voltage levels of the external power with a logic device; detecting duration and amplitude of voltage drops of the voltage level; generating an alarm signal whenever the duration and amplitude of the voltage drops exceed a predetermined threshold.

The invention may further comprise a method of reducing the ability to disable a telematics remote tracking unit by including anti-defeat countermeasure features comprising: providing internal backup batteries in the telematics remote tracking unit to provide power whenever external power is lost; providing flash suppression circuitry in series with the external power; providing multiple isolated ground planes for separate circuits in the telematics remote tracking unit; providing a conductive polymer housing that protects telematics remote tracking unit circuitry from electrical and electromagnetic impulses; providing antennas that are disposed internally within the telematics remote tracking unit adjacent windows in the housing that are non-conductive and transmit electromagnetic waves.

### BRIEF DESCRIPTION OF THE FIGURES

In the FIGURES,

FIG. 1A is a diagram illustrating one application of the present invention;

FIG. 1B is a more detailed diagram illustrating one application of the present invention;

FIG. 2 is a side view of one example of the manner in which a remote unit can be constructed according to the present invention;

FIG. 3 is a block diagram of one embodiment of a remote unit according to the present invention;

FIG. 4 is a schematic diagram of a battery backup system that may be incorporated in a remote unit of the present invention;

FIG. 5 is a schematic diagram of a transient protection circuit shown in FIG. 4;

FIG. 6 is a flow chart illustration of the operation of the remote unit that may be used with one embodiment of the present invention; and

FIG. 7 is a flow chart illustrating the steps that are performed in the process of storing location date.

FIG. 8 is a flow diagram illustrating the steps for adjusting the transmission rate based upon the speed of the remote unit;

FIG. 9A is a flow diagram illustrating the steps for reducing data to be transmitted from the remote unit;

FIG. 9B is a flow diagram illustrating the steps for reconstructing data at the base station;

FIG. 10 is a flow diagram illustrating the steps performed in the dead reckoning process.

### DETAILED DESCRIPTION OF THE INVENTION

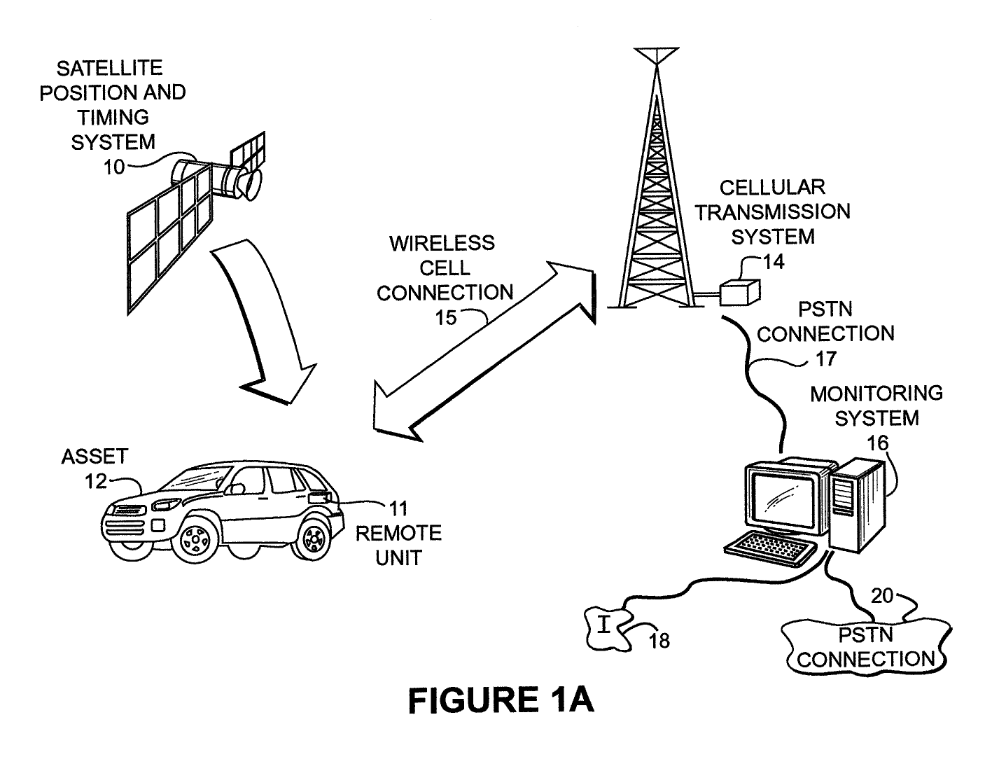

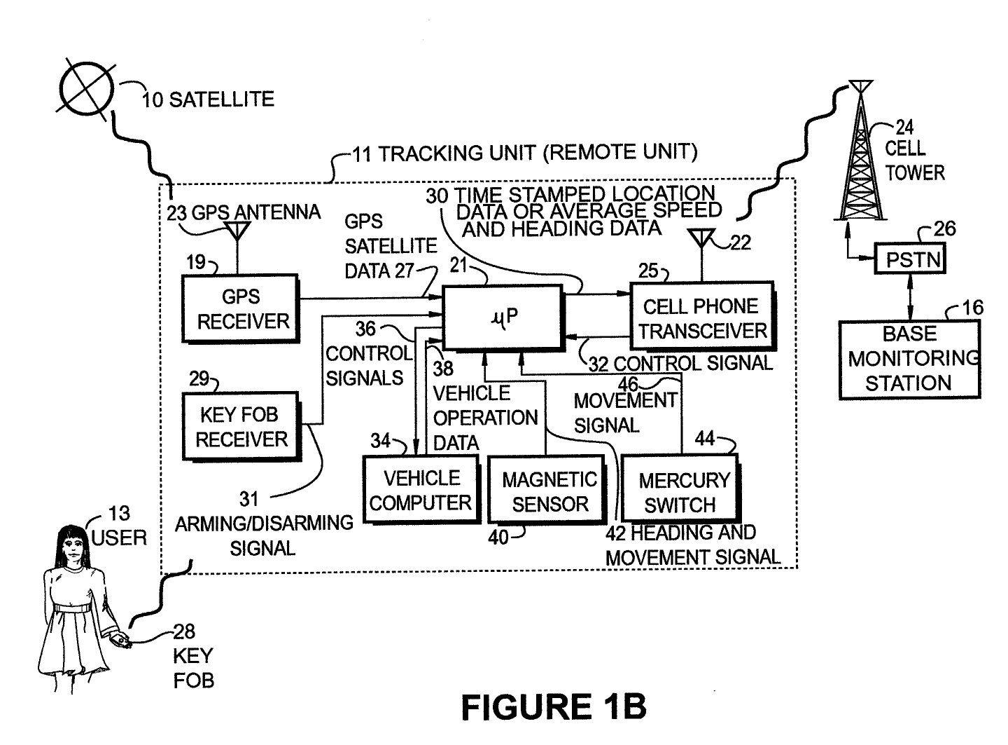

FIG. 1 illustrates one application of the present invention. A satellite 10 transmits information, such as timing and position information, to a remote unit (not shown) contained in asset 12. The remote unit receives and transmits signals to a wireless transmission system 14. Wireless transmission system 14 also receives and transmits signals to a monitoring base station unit 16 via a public switch telephone network connection 17. As shown, the remote unit 11 and monitoring base station unit 16 are in communication with each other. Although FIG. 1 shows communication between monitoring base station unit 16 and the remote unit 11 using only a PSTN connection 17, any other desired type of transmission system can be used to couple transmission system 14 and monitoring base station unit 16. For example, such a transmission system can comprise a cell link, a microwave system, cable, fiber optic, etc. Hence, the present invention is not limited to the type or number of transmission systems that couple the remote unit 11 and the monitoring base station unit 16. The monitoring base station unit 16 is also connected to the internet 18 and to another public switched telephone network (PSTN) connection 20 to send and receive data from other sources. In that regard, data generated and stored by the monitoring base station 16 can be posted to a predetermined website for access by users or accessed by logging onto a server coupled to the monitoring base station 16. For example, a user of the system may wish to track a particular asset 12. This tracking function may be provided by establishing a website for a particular company or individual having one or more assets that it desires to track. This website can then provide the information which is transmitted by the monitoring base station 16 to the website over the Internet 18. Further, telephone calls may be automatically placed by the monitoring base station 16 over the PSTN connection 20 upon the occurrence of a particular condition. The monitoring base station 16 may also automatically contact the police or computers operated by the police, or other law enforcement officials to provide information regarding an asset that may be stolen, etc. via Internet connection 18 or PSTN connection 20. Further, an automated voice call can be placed to the user or the police over PSTN connection 20 upon the occurrence of a predetermined condition relating to the asset 12, such as a theft to the asset.

As indicated above, the system of the present invention includes a tracking unit that utilizes a cell phone transceiver that is connected to, and used in combination with, a GPS receiver that can be used as a tracking device. The device is mounted in a box that is placed on a vehicle. The tracking unit communicates with a base monitoring station using the cellular transceiver that is connected to the PSTN. The device may be mounted in the vehicle in a location such as the front or rear dash and is coupled to the power system and possibly the computer system of the vehicle. When the driver locks the vehicle using a key fob, the remote unit detects the locking signal generated by the key fob so that the remote unit is armed. An alarm condition can occur when the ignition is started without disarming the tracking unit, or if the vehicle is moved greater than some predetermnined distance, such as a quarter mile. The system was designed to determine if the tracking unit has moved a predetermined distance by making such a determination at the base monitoring station.

As shown in FIG. 1B, the tracker unit 11 includes a GPS receiver 19 that receives location information signals from a satellite 10 via a GPS antenna 23. The GPS receiver 19 generates GPS satellite signals 27 that are sent to a microprocessor 21. The GPS receiver 19 and microprocessor 21 are provided by SiRF Inc. Microprocessor 21 processes the GPS location signals 27 to provide latitude and longitudinal location data. Computer program code is provided by SiRF Inc. to perform this function.

As also shown in FIG. 1B, microprocessor 27 time stamps the latitude and longitudinal location data 30 to provide time stamped data that is transferred to a cell phone transceiver 25. Microprocessor 21 may also produce average speed and heading data 30 that is also transferred to the cell phone transceiver 25. When the dead reckoning process is activated, the cell phone transceiver 25 is connected to a cell phone antenna 22 that transmits the time stamped location data or average speed and heading data to a cell tower 24 which is in turn connected to the public switch telephone network (PSTN) 26. The call that includes the time stamped location data or average speed and heading data 30 is routed via the PSTN 26 to a monitoring station 16. Monitoring station 16 performs various functions such as calculating alarm conditions and generating control signals that are transferred from the monitoring station 16 through the PSTN 26 to the tower 24 to the cell phone antenna 22 and the cell phone transceiver 25. These control signals 32 from the cell phone transceiver 25 are then transferred to the microprocessor 21 where they are processed. These control signals may be used, for example, as control signals 36 by the vehicle computer 34 to disable the ignition of the vehicle, or perform other functions via the vehicle computer 34. Vehicle computer 34 also generates vehicle operation data 38 that is transferred to the microprocessor 21 for processing, and is used by the microprocessor 21 to make various decisions. A magnetic sensor 40 is also connected to the microprocessor 21 and provides heading and movement signals 42. The magnetic sensor 40 can comprise any automated compass that can provide instantaneous heading information and can also indicate whether the vehicle has been moved from a stationary position by detecting a change in the magnetic sensor 40. A mercury switch 44 may also be connected to the microprocessor 16. Mercury switch 44 can indicate movement of the vehicle by generating a movement signal 46 that is applied to the microprocessor 16.

The tracking unit 11 can be armed by an individual 13 by activating a key fob 28. The key fob 28 is similar to a standard key fob that is used to lock the vehicle doors. A key fob receiver 29 is located within the tracking unit 11 and receives the key fob signals in the same manner that the vehicle receives the key fob signals to lock the vehicle doors. The key fob receiver 29 is coded with the same code that the vehicle uses for locking and unlocking the vehicle. In that fashion, the vehicles can be locked and unlocked and the tracking unit 11 can be activated and deactivated. The key fob generates an arming/disarming signal 31 that is applied to microprocessor 21.

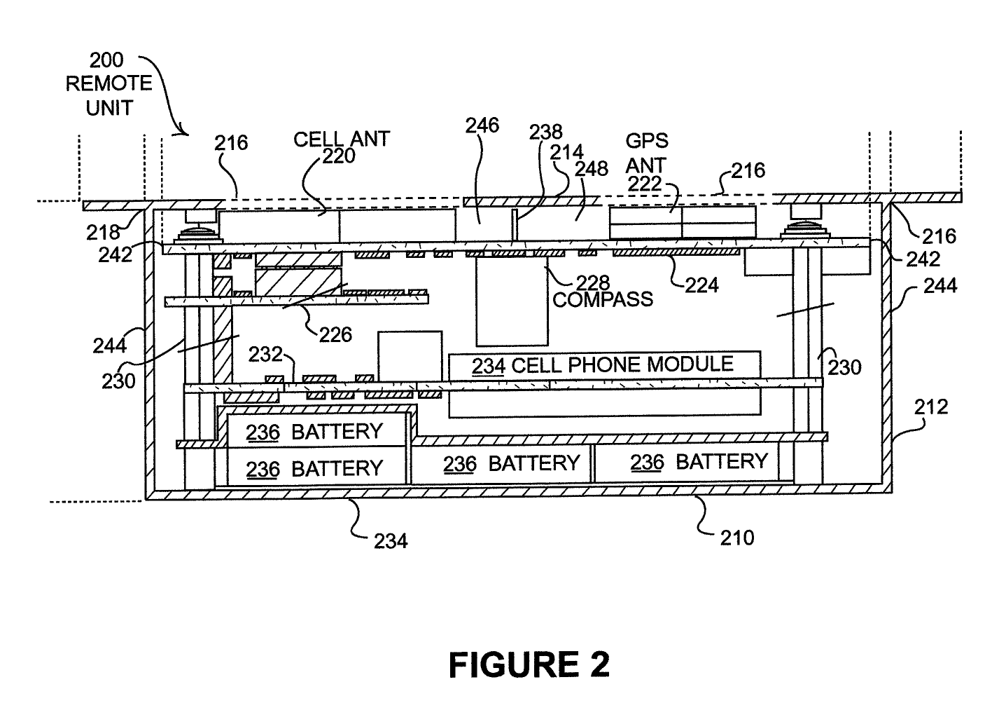

FIG. 2 illustrates one implementation of a remote unit 200 that can be used in accordance with the present invention. Remote unit 200 comprises a housing 210 that includes a receptacle 212 and a lid 214. Preferably, housing 210 is comprised of a conductive polymer, except for windows 216 of lid 214. The polymer preferably will protect internal components from shocks or impulses. Windows 216 do not include the conductive characteristic of the remainder of housing 210 so that electromagnetic RF radio wave signals can pass with minimum impedance through housing 210 to antennas mounted within receptacle 212. If desired, lid 214 can simply define windows 216 as being physically open. Receptacle 212 is preferably seam welded to lid 214 at joints 216 and 218.

Remote unit 200 of FIG. 2 also includes a cell antenna 220 and a GPS antenna 222 disposed on one side of a PCB 224. Disposed on the other side of PCB 224 are a GPS receiver (not referenced), a compass 228 and a modem (not referenced). PCB 224 is coupled to receptacle 212 by legs 230. Disposed adjacent to PCB 224 is a PCB 226. PCB 226 supports a power supply (not referenced) for remote unit 200.

Legs 230, illustrated in FIG. 2, also couple a PCB 232 to receptacle 212. PCB 232 has a cellular radio module 234 that includes circuitry to receive and transmit signals using cellular radio protocols. Disposed as shown adjacent to a bottom of receptacle 212 are internal backup batteries 236. Legs 230 provide conduction between batteries 236 and PCBs 224, 226 and 232 for power and ground.

The remote unit of the present invention includes anti-defeat counter-measure features. These features are: the combination of two antennas on a single substrate that are isolated from one another and which are contained within the housing of the remote unit; an internal backup battery disposed within the remote unit to prevent disabling of the remote unit by cutting the power cord; and incorporation of flash suppression circuitry within the remote unit such as varisters, xener diodes and ferrite beads to prevent disablement of the remote unit by application of high energy pulses.

Referring again to FIG. 2, a fence 238 extends away from PCB 224 and to, but not contacting, lid 214. Fence 238 is disposed between antennae 220 and 222. Preferably, fence 238 is conductive and is coupled to a ground plane in PCB 224 that is substantially the same dimension as PCB 224. PCB 224 defines edges 242 that are adjacent to, but not contacting, walls 244 of receptacle 212.

In addition, a ground plane for antenna 220 is isolated from a system ground of the remote unit 200. The ground plane is a multiple integer of a fraction of the desired wavelength in diameter and is also spaced from antenna 220 by a multiple integer of a fraction of the desired wavelength. As such, a tuned isolated ground plane is provided. To illustrate, the ground plane for cellular radio module 234 is the same size as the metalization on antenna 220. This isolated ground plane is coupled directly to the antenna input of cellular radio module 234.

The coupling of antenna 222 to the antenna input of the GPS receiver includes two ground planes that sandwich a conductor. The distances between each ground plane and the sandwiched conductor are a fraction of the desired wavelength, and are preferably equal. The dimensions of the conductor, such as the width, are proportional to the distances. The conductor feeds directly to the antenna input of the GPS receiver.

Accordingly, lid 214, PCB 224, fence 238, the ground planes and walls 244 define respective chambers 246 and 248. Chambers 246 and 248 at least minimize the electromagnetic interference between antennas 220 and 222. If desired, either or both edges 242 can contact walls 244, and fence 238 can contact lid 214. Or, lid 214 can have a projecting part that either contacts fence 238 or eliminates fence 238. Similar projecting parts for walls 244 may be employed with respect to edges 242. Another feature of the present invention is that there are three ground planes: one for the antennas, another for the compartment isolation and a third for the logic or circuits. All of these are located in or on PCB 224.

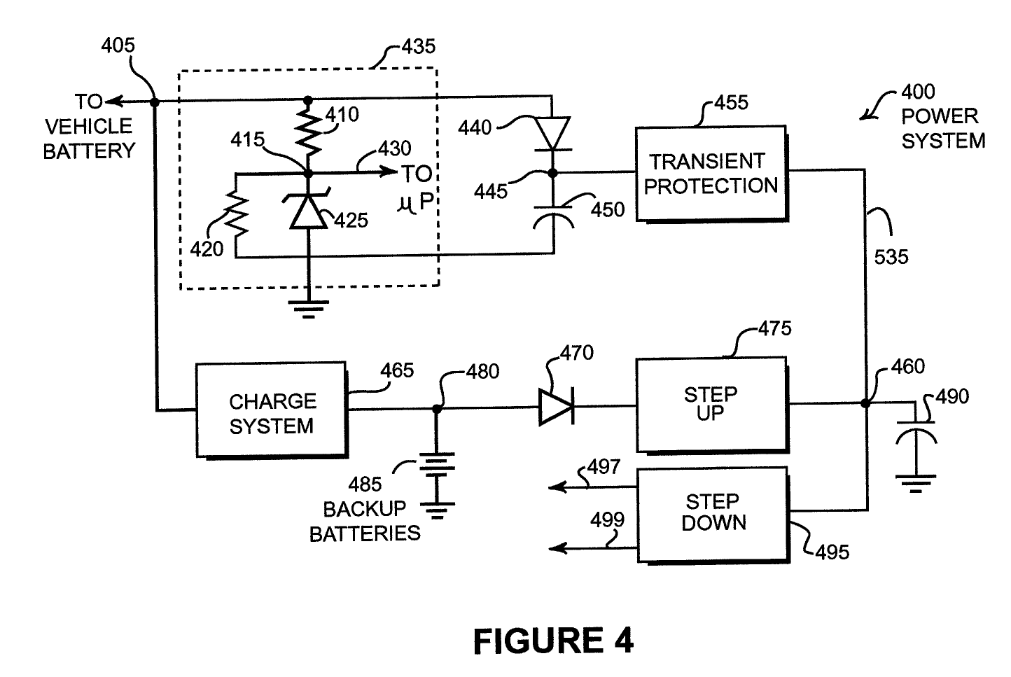

Another anti-defeat countermeasure feature is the use of internal backup batteries 236 within remote unit 200 to prevent disabling of remote unit 200 by cutting the power cord. To illustrate this feature, reference is made to FIG. 4. FIG. 4 shows a schematic for a power system 400. A node 405 is connected to a power cord (not shown) that couples power system 400 to an external power supply, such as a vehicle battery. Coupled between node 405 and a node 415 is a resistor 410. Coupled in parallel between node 415 and ground are a resistor 420 and a zener diode 425. These components make up a monitor voltage circuit 435. Preferred values for resistors 410 and 420 are 3.5 KΩ and 100 KΩ, respectively.

One of the purposes of monitor voltage circuit 435 is to provide a voltage to be monitored by a sensor circuit (such as microprocessor, not shown) coupled to node 415 by a lead 430. Monitor voltage circuit 435 provides a predetermined voltage at node 415 to the sensor circuit. If the predetermined voltage changes, the sensor circuit will detect that change. For example, if node 405 is coupled to a vehicle battery, then monitor voltage circuit 435 will provide a predetermined voltage at node 415. If the coupling between node 405 and the car battery is broken, then the voltage at node 415 will drop. The sensor circuit coupled to node 415 will sense that voltage drop. In practice, this feature can be used to detect when the vehicle battery is dead, when the battery is disconnected from the vehicle or when the battery is disconnected from node 405. If desired, an alarm condition may be set and the remote unit will act accordingly.

In some circumstances, the voltage provided at node 415 may momentarily change due to an accepted function of the vehicle. To illustrate, the vehicle battery that is connected to node 405 may also be used to start an engine of the vehicle. The voltage at node 415 will drop momentarily as the vehicle's engine draws current from the battery. In this case, the microprocessor is programmed to detect the voltage drop and to determine the duration and magnitude of the voltage drop to make a determination as to whether the battery is dead or has been disconnected. The microprocessor can monitor the voltage at node 415 to access at least two predetermined voltage levels to assist in making a determination of the existence of a proper external supply.

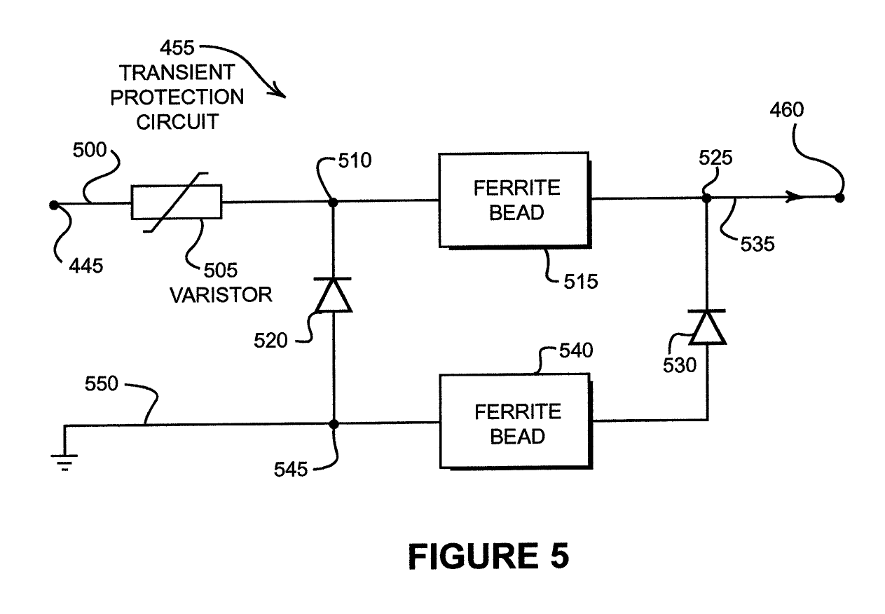

Coupled between node 405 and a node 445 is a diode 440. Coupled between node 445 and ground is a capacitor 450 that has a preferred value of 22 μF. Coupled between node 445 and a node 460 is a transient protection circuit 455. Transient protection circuit 455 will be explained in greater detail below with reference to FIG. 5. Coupled between node 405 and node 460 are a charge system 465, a node 480, a diode 470 and a step-up circuit 475. Coupled between ground and node 480 is a battery 485. Battery 485 corresponds to the backup batteries 236 in FIG. 2. Coupled to node 460 is a capacitor 490 that has a preferred value of 22 μF. Further coupled to node 460 is a step down circuit 495. Step down circuit 495 provides the same or different voltages on leads 497, 499 to the components of remote unit 200 shown in FIG. 2.

In operation, power is supplied to node 405 from the vehicle battery or other external source. Monitor voltage circuit 435 provides a predetermined voltage on lead 430. The voltage at node 405 is decreased to a predetermnined voltage at node 460 as a result of the voltage drop across varistor 505. For a voltage of 12 V at node 405, the predetermined voltage at node 460 is preferably 7.2 V. This predetermined voltage at node 460 is stepped down by step down circuit 495 to preferably two different voltages on leads 497, 499. These two preferred voltages are approximately 3 V and 5 V. Step down circuit 495 can be a voltage divider, for example, or any other device or circuit that steps down an input voltage. In addition, charge system 465 uses the power provided at node 405 to charge or maintain the voltage of battery 485 during normal operation.

If power ceases to be provided at node 405, and this is detected by the microprocessor connected to node 415, power is provided to node 460 by battery 485 through step-up circuit 475. Step-up circuit 475 can be a charge pump, for example, or any other device or circuit that can increase the voltage level. The preferred voltage provided by step-up circuit 475 is 7.2 V. This voltage is subsequently decreased by step-down circuit 495, as previously described.

If a power transient is present at node 405, transient protection circuit 455 will minimize or eliminate the transient. A preferred embodiment of the transient protection circuit 455 is shown in FIG. 5. Transient protection circuit 455 includes a lead 500 that couples a varistor 505 to node 445 in FIG. 4. Varistor 505 is coupled to a node 510, which is also coupled to a ferrite bead 515 and a transient-suppressing diode 520. Ferrite bead 515 is also coupled to a node 525, which is coupled to a transient-suppressing diode 530 and a lead 535. Lead 535 couples node 525 to node 460 in FIG. 4. Transient-suppressing diode 530 is coupled to ferrite bead 540, which is coupled to a node 545. Transient-suppressing diode 520 is also coupled to node 545. Node 545 is coupled to ground by a lead 550. The ferrite beads 515, 540 protect node 460 from current spikes while the breakdown voltage of diodes 520, 530 protects node 460 from voltage spikes.

Referring again to FIG. 2, the operation of the tracking or remote unit 200 of the present invention utilizes a radio module, such as a cell phone transceiver 234, that is connected to and used in combination with a GPS receiver that can be used as a tracking device. The device is mounted in a housing 210 that is placed in a vehicle, preferably hidden. The remote unit 200 communicates with a monitoring base station 16 using the cellular transceiver 234 that is connected to the monitoring base station 16 via the public switch telephone network (PSTN) connection 17. The remote unit may be mounted in the vehicle in a location such as the front or rear dash, and is coupled to the power system of the vehicle, and is optionally coupled to the computer system of the vehicle. When a driver locks the vehicle using a key fob, the remote unit 200 detects the locking signal generated by the key fob and arms itself. Activating an input device that is coupled to the remote unit 200 can also arm the remote unit 200. Such input device can be a pressure-sensitive device that, once depressed, causes a signal to be provided to the remote unit 200. The remote unit responds by proceeding to an armed state.

An alarm condition can occur if the ignition is started without disarming the remote unit or if the vehicle is moved greater than predetermined distance that can be selected by the user. The monitoring base station 16 determines if the remote unit has moved the predetermined distance from information provided by the remote unit. Such information includes location and timing information, preferably obtained from GPS information. Alternatively, the remote unit can determine on-board if the remote unit, and hence the vehicle, has moved a predetermined distance.

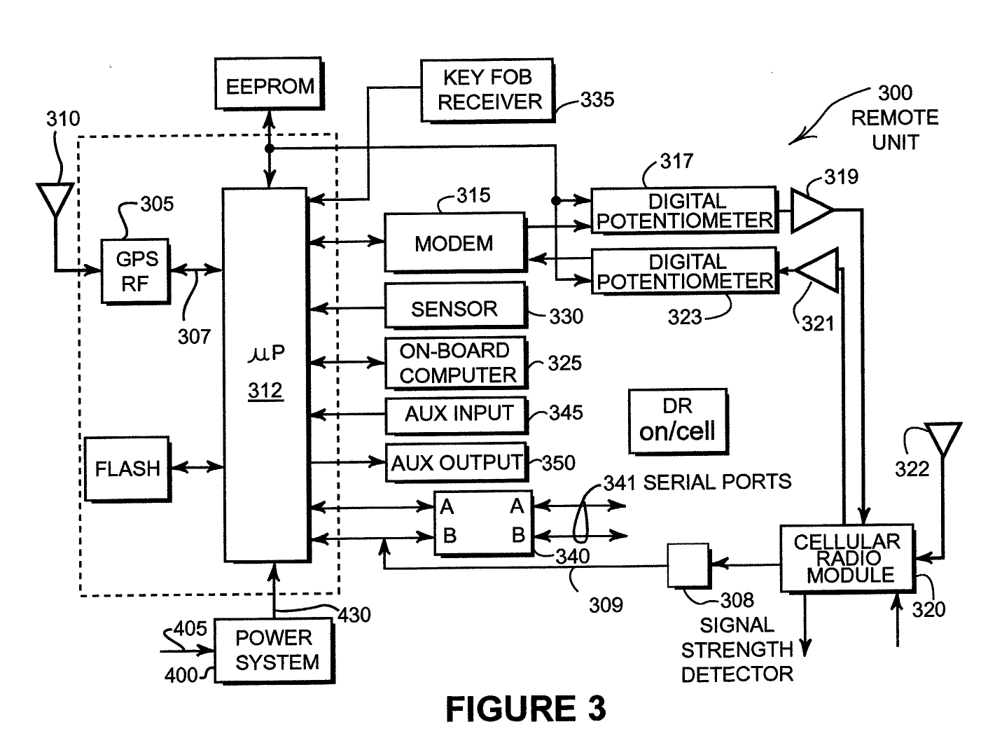

As shown in FIG. 3, a remote unit 300 includes a GPS receiver 305 that receives location information signals from a satellite (FIG. 1) via a GPS antenna 310. The GPS receiver 305 generates GPS satellite signals and provides them over a lead 307 to a microprocessor 312. The GPS receiver 305 and microprocessor 312 are preferably provided in a two-chip set or as a single chip. The preferred implementation uses a SiRF GSP2e chipset that is provided by SiRF Technology, Inc., 148 E. Brokaw Road, San Jose, Calif. 95112. Microprocessor 312 under the control of program code provided by SiRF Technology, Inc. processes the GPS location signals to provide latitude and longitudinal location data along with time data.

Microprocessor 312 time stamps the latitude and longitudinal location data. This time-stamped data is provided to a modem circuit 315. Modem 315 is preferably a CMX469A provided by MX-COM, Inc., 4800 Bethania Station Road, Winston Salem, N.C. Modem 315 is a full-duplex pin-selectable 1200/2400/4800 bps Minimum Shift Key (MSK) Modem for FM radio links. Modem 315 modulates this data and provides that data to digital potentiometer 317. Amplifier 319 receives the time-stamped data from potentiometer 317, amplifies the data and provides the amplified data to cellular radio module 320. Module 320 is preferably a CRM4100 device from Standard Communications Corporation. Module 320 preferably is a data transceiver designed to work with North American Advanced Mobile Phone Systems (AMPS) technology. Microprocessor 312 sets the transmit and receive levels through potentiometers 317 and 323. Thus, the remote unit can be used with an type of RF device including digital cellular technology and paging technology.

Microprocessor 312 of FIG. 3 may also produce average speed and heading data that is also transferred to the module 320. This data is used for a dead reckoning process of remote unit 300. Dead reckoning is activated when GPS information is not available, such as when GPS receiver 305 does not receive signals from three or more GPS satellites.

Module 320 of FIG. 3 is connected to a cell phone antenna 322 that transmits the time stamped location data or average speed and heading data to a cell tower 14 (part of wireless cellular transmission system 14 in FIG. 1) that is typically connected to the PSTN connection 17. The transmitted time-stamped location data or average speed and heading data 30 is routed to a monitoring base station 16 (FIG. 1). The monitoring base station 16 performs various functions such as calculating alarm conditions and generating control signals that are transferred from the monitoring base station through the PSTN connection 17 (FIG. 1) to antenna 322 and cellular radio module 320. These control signals from module 320 are then transferred through amplifier 321, digital potentiometer 323 and modem 315 to microprocessor 312 where they are processed. These control signals may be used, for example, as control signals for vehicle on-board computer 325 to disable the ignition of the vehicle, or perform other functions via the vehicle computer 325.

As also shown in FIG. 3, the on-board vehicle computer 325 also generates vehicle operation data that is transferred to the microprocessor 312 for processing that can be used by microprocessor 312 to make various decisions. Also, the system that comprises the remote unit 200 and the monitoring base station unit 16 use GPS information until the GPS signal is lost. At that point, the monitoring base station 16 uses the last known GPS signal and calculates position based upon the dead reckoning information, i.e., the speed from the computer of the vehicle and the elapsed time that is calculated at the monitoring base station 16. In other words, the remote unit 200 sends the raw speed and directional data, as well as the last GPS location data to the monitoring base station unit 16, which then calculates the present position of the remote unit based upon elapsed time.

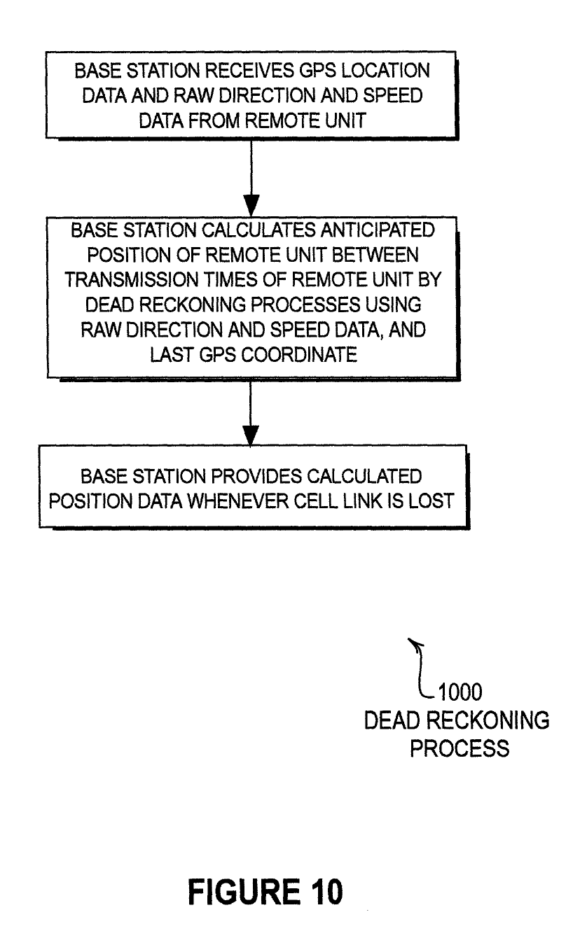

FIG. 10 illustrates the steps 1000 that may be used by a processor located in the base station. At step 1002, the base station receives the GPS location data and raw direction and speed data from the remote unit. At step 1004, the base station calculates the anticipated position of the remote unit between the transmission times of the remote unit by dead reckoning processes using the raw direction and speed data and the last GPS coordinate. In other words, the processor in the base station determines the last GPS coordinate and calculates an anticipated or predicted location of the remote unit using the raw direction and speed data that has been received by the base station together with the GPS location information. At step 1006, the base station can then provide the base station operator with a calculated position whenever the cell link is lost.

As further shown in FIG. 3, sensor 330 is coupled to microprocessor 312. Sensor 330 can be a magnetic sensor that provides heading and movement signals 42. The magnetic sensor can comprise any automated compass that provides heading information, preferably instantaneously, and can also indicate whether the vehicle has been moved from a stationary position. In addition to, or substituting for, the magnetic sensor, a mercury switch can also be coupled to microprocessor 312. The mercury switch can indicate movement of the vehicle by generating a movement signal that is applied to microprocessor 312. Also, an accelerometer can be included in sensor 330. Furthermore, sensor 330 can include any sensor that is coupled to computer 325. This may be done where specific utilization of remote 300 requires a direct connection to a sensor coupled to computer 325.

Activating a key fob by the user arms remote unit 300. In this case, the key fob is similar to a standard key fob that is used to lock the vehicle doors. A key fob receiver 335 is located within remote unit 300 and receives the key fob signals in a manner similar to the manner in which the vehicle receives the key fob signals to lock the vehicle doors. Key fob receiver 335 is preferably coded with the same code that the vehicle uses for locking and unlocking the vehicle. In that fashion, the vehicle can be locked and unlocked, while remote unit 300 is simultaneously activated and deactivated all from the same actuator. Alternatively, the key fob can have a separate actuator for activating and deactivation remote unit 300 separately from locking and unlocking the vehicle. In addition, the key fob can be used to generate a panic signal. This will cause the remote unit to be in an alarm mode and operate accordingly.

Remote unit 300 of FIG. 3 also includes an interface 340 that has serial ports 341 labeled A and B. Interface 340 can be used to couple a diagnostic board to microprocessor 312. Also, other devices can be coupled to microprocessor 312 through interface 340, such as a keyboard, display, a handset or a cell phone with a handset display. Thus, interface 340, when not used with the diagnostic device, can be used for future expansion to some other module.

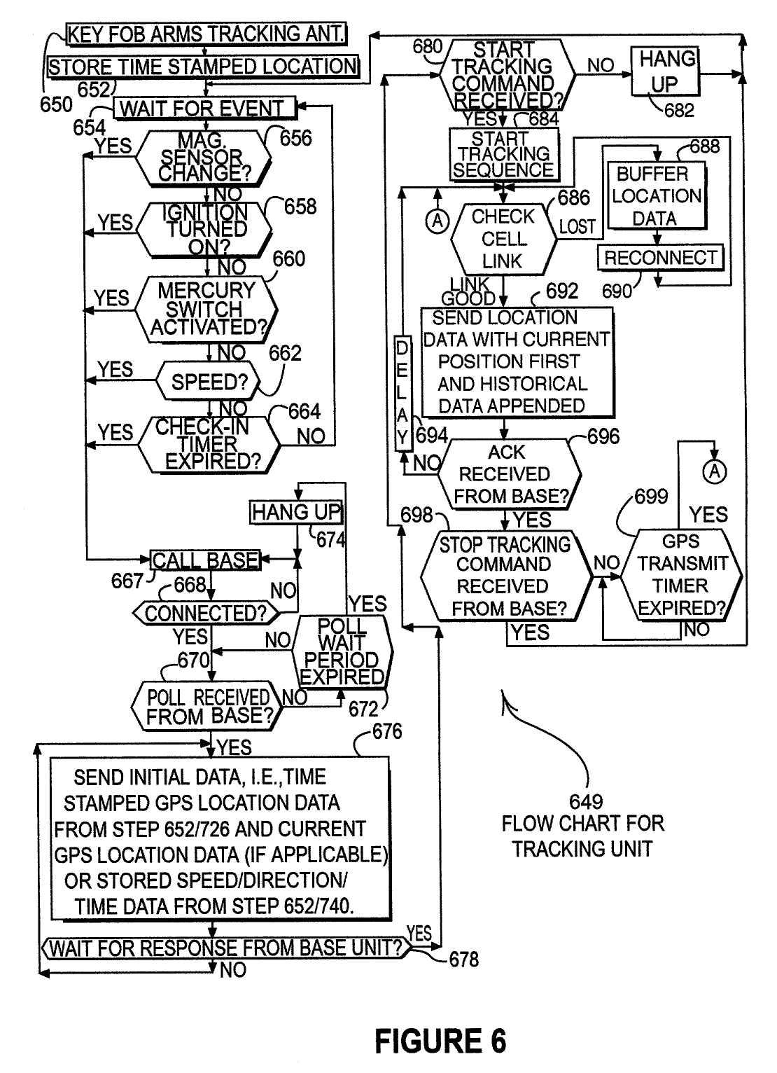

FIG. 6 is a flow diagram illustrating the functions 649 that are performed by the remote unit 300 that is illustrated in FIG. 3. At step 650, the key fob arms remote unit 300 as indicated above. At step 652, time stamped location information is stored by the microprocessor 312. The location data can constitute latitude and longitudinal data that has a time stamp indicating the time at which the GPS receiver 305 (FIG. 3) detected the location information. At step 654, the microprocessor 312 waits for an event to occur. An event can constitute an output signal by the magnetic sensor (e.g., one of the sensors 330), a detection signal that indicates that the ignition of the vehicle has been turned on, an output signal from a mercury switch (e.g., one of the sensors 330) indicating that the vehicle has been moved, an output from computer 325 (FIG. 3) that there is a speed reading for the vehicle, an output indicating that a check-in timer has expired, or any similar type of event sensor that has been built into the system for detection of an event.

FIG. 6 illustrates a series of decision steps to detect an event such as described above. At decision block 656, it is determined whether the magnetic sensor has sensed a change and generated an output. At decision block 658, the vehicle computer 325 is checked to see if the ignition has been turned on for the vehicle. At decision block 660, it is determined whether the mercury switch has generated a movement signal. At decision block 662, it is determined whether the vehicle computer 325 has generated vehicleoperating data that indicates there is a speed indication for the vehicle. At decision block 664, a timer is set that is referred to as a check-in timer that indicates a check-in call should be made by the remote unit to the base station. Decision block 664 determines if the check-in timer has expired. Remote unit 300 (FIG. 3) can be configured in any desired fashion to detect one or more of these outputs either signally or in combination. Again, the remote unit can perform any combination of these specific functions.

Referring again to FIG. 6, if any of these functions are detected, the remote unit 300 (FIG. 3) calls the base monitoring base station 4 (FIG. 1) at step 66. It is then determined at step 668 whether the remote unit 300 is connected through the cell phone connection to the PSTN. If it is not, the process proceeds back to step 667 to continue to call base monitoring station 4. When a connection is established to the base monitoring station, it is determined at step 670 whether a polling request has been received from the base monitoring station (FIG. 1). If the polling request has not been received from the base monitoring station (FIG. 1), it is determined by the microprocessor 312 (FIG. 3) whether a poll-waiting period has expired at step 672. If the poll waiting period has expired and a poll has not been received from the base monitoring station by the microprocessor 312, the cell phone call is disconnected at step 674 and the process proceeds back to step 667 to reestablish a connection with the base monitoring station. If the poll-waiting period has not expired at step 672, the process returns to step 670 to determine if a poll has been received from the base monitoring station.

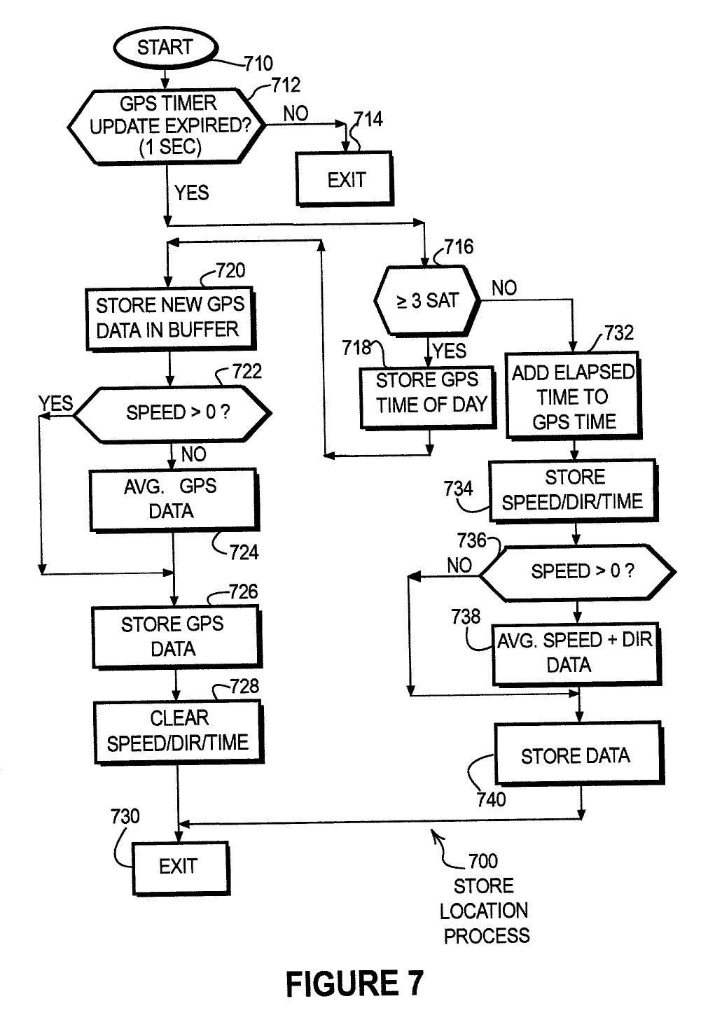

As also shown in FIG. 6, when the polling request has been received from the base monitoring station at step 670, the process proceeds to step 676 to send the initial data. The initial data constitutes the time stamped GPS location data that was stored at step 652 in accordance with process step 726 (FIG. 7). Additionally, the current GPS location data is sent if steps 654 through 670 have exceeded the GPS timer update that is determined in step 712 (FIG. 7). Alternatively, the stored speed/direction/time data that is generated in accordance with step 740 (FIG. 7) is stored at step 652 above. It is then determined at step 678 whether a response has been received from the base monitoring station. If it has not, the process returns to step 676. If a response has been received from the base monitoring station, the process proceeds to step 680. At step 680, it is determined whether remote unit 300 from the base monitoring station has received a start tracking command. If it has not, the system hangs up at step 682 and returns to step 654. If a start tracking command signal has been received, the system starts its tracking sequence at step 684. The tracking sequence is a process of periodically detecting GPS location information or generating dead reckoning location information and storing this information in accordance with the process steps illustrated in FIG. 7.

FIG. 6 then proceeds to step 686 where it is determined if a cell phone link connection has been maintained. If the cell phone link has been lost, the process proceeds to step 688. At step 688, the location data such as the GPS data or average speed/direction data is stored in a buffer. The process then proceeds to step 690 to attempt to establish a reconnection of the cell connection between remote unit 300 and the base monitoring station. The process then proceeds to step 686 to determine if the cell link has been established. If the cell link remains connected, location data (i.e. GPS location data or average speed and direction data) are sent to the base monitoring station via the cell phone link. The current position or location data is sent first with any historical data that has been stored at step 688 appended to the current location data. The appended data may constitute a portion of the historical data that is transmitted with a series of current location data transmissions. Remote unit 300 then determines whether an acknowledgment has been received from the base monitoring station that the base monitoring station has received the location data. If an acknowledgment has not been received, a delay is established at step 694 and the process returns to step 686. If an acknowledgment is received by remote unit 300 from the base monitoring station, it is determined at step 698 whether a stop tracking command signal has been received from the base unit. If the remote unit 300 from the base unit has received a stop tracking command signal, the process proceeds to step 654 to wait for an event. If remote unit 300 from the base monitoring station has not received a stop tracking command, the process proceeds to step 699 to determine if the GPS transmit timer has expired. The GPS transmit timer determines the repetitive period for which GPS information is periodically sent from remote unit 300 to the base monitoring station. If that period has not expired, the process loops on itself until the period has expired. When the period has expired, the process returns to step 686.

FIG. 7 is a flow diagram illustrating the steps 700 that are performed in the process of storing location data. At step 710, the process is started for storing location data. At step 712, a determination is made whether the update timer for storing the location data has expired. For example, the update timer may be set at one second. The flow chart illustrated in FIG. 7 may start at step 710 based upon an interrupt signal to microprocessor 312 (FIG. 3) that indicates that the update timer should be checked. If the update timer has not expired, the process illustrated in FIG. 7 exits at step 714 and proceeds back to the queue of microprocessor 312 after the interrupt has been processed. If a determination is made, at step 712, that the update timer for the location data has expired, the process proceeds to step 716 where a determination is made whether the GPS receiver 305 (FIG. 3) is receiving signals from three or more GPS navigation satellites. If GPS receiver 305 is receiving signals from three or more GPS satellites, the process proceeds to step 718 to store the GPS time of day. The process then proceeds to step 720 to store the new GPS data in a buffer.

At step 722, a determination is made whether there is movement of the vehicle. This can be done by determining if the speed of the vehicle—provided from the computer 325 in FIG. 3—is greater than zero or if any one of the event sensors in sensor 330 (FIG. 3) has indicated movement, such as the events determined at steps 656, 658 and 660 that are illustrated in FIG. 6. If no movement has been detected, the GPS location data is averaged at step 724. If movement is detected, the process proceeds to step 726 where the GPS location data is stored in a buffer. At step 728, the speed/direction/time buffer is cleared and the process exits at step 730.

As also shown in FIG. 7, if a determination is made that three or more satellite signals are not being received at step 716, the process proceeds to step 732 where the expired time is added to the GPS time that was last stored at step 718. At step 734, the speed/direction/time data received from the sensor 330 and vehicle computer 325 are stored. At step 736, it is determined whether the vehicle has moved in the same fashion as determined at step 722. If the vehicle has moved, an average of the speed and direction is determined at step 738. If the vehicle has not moved, the process proceeds directly to step 740 to store the average speed and direction data. The average speed and direction data from step 738 is also stored at step 740. The process then proceeds to step 730 to exit.

As can be seen from the flow process of FIG. 7, the GPS location data may be stored, or alternatively, speed and direction data may be stored, which is then sent to the base monitoring station 4, as indicated in FIG. 1. In this fashion, the base monitoring station can determine if the vehicle has moved beyond a predetermined perimeter to thereby generate an alarm condition. The determination of the movement beyond the perimeter is not done by remote unit 300, but rather, performed in the base monitoring station 4. Only data relating to speed and direction is sent to the base monitoring station 4 when the GPS signal is lost. When the GPS signal is still being received, only the GPS location information is sent to the base monitoring station 4 so that the base monitoring station 4 can calculate whether remote unit 300 has moved beyond a predetermined perimeter.

An example of asset protection against theft assumes that the asset is stationary, such as a vehicle that is parked. Now, the alarm has been activated. The present invention can be configured, as explained above, to provide GPS location information to the base station. The base station will then determine if the asset moves outside a predetermined boundary. One method of determining that situation is to collect samples of location data from the remote unit on the asset. Knowing the error of that location data and compensating accordingly, a more accurate location of the asset can be determined from the samples. If desired, the predetermined boundary can be changed, such as a decrease in boundary area or volume, to take into account this greater accuracy. Then, if the asset travels beyond that boundary after considering the error of the GPS location data, the base station can determine an alarm state exists and responds accordingly.

Alternatively, the last known position of the asset or an average of a several last known positions can be used as a reference point. In this case, if the asset moves a predetermined distance from that reference point after considering the error of the GPS location data, then the base unit can signal an alarm. Another alternative is that the predetermined boundary takes into account the error of the GPS location data. Depending on how the base station is programmed, if a single GPS location datum is or GPS location data are beyond that boundary, an alarm situation may exist. Another alternative is that the remote unit will not report a change in GPS location if the change falls within the error of the GPS information.

To illustrate further, when the alarm state of the remote unit is activated, because of the error of the GPS location data the predetermined boundary is dimensioned so that no matter where the asset is or what the GPS location data error is at the moment the alarm is activated, the predetermined boundary is large enough so that the error will not place the asset outside the boundary. The threshold for determining if the asset is outside the boundary can be only one GPS location datum outside the boundary, or two or more datum, which ever is desired. In addition, the present invention contemplates that the predetermined boundary can be defined by any shape, such as circle, rectangle, polygon, or a set of points that define a perimeter of the boundary.

When the cell connection is lost, data in the form of GPS location information or speed and direction data is buffered and then sent to the monitoring base station 16 upon reacquisition of the cell connection between remote unit 300 and the monitoring base station 16. Accumulated data is therefore not sent at predetermined time periods but upon reacquisition of the cell connection. Further, data is transmitted from the buffer in accordance with the level at which the buffer is filled upon reacquisition of the cell connection. Also, the data is not continuously transmitted once the cell connection is reestablished. Rather, the location data is sent in periodic bursts from remote tracking unit 300 to the monitoring base station 16.

With reference FIG. 2, the tracking device has an on-board battery pack. By coupling the remote unit to the power system of the vehicle, the on-board battery pack power supply can be maintained. If those wires are cut in an attempt to disable the device, a change in the power level is detected and an alarm condition is created. Further, if a low battery condition is detected, an alarm condition is also created. This over-all concept, together with the entire device being packaged in an enclosed, secure, tamper-proof casing that includes all of the elements such as the antennas and power supply within the casing.

When an alarm condition is generated, the remote unit transmits a current location signal over the cell phone link. However, when a cell phone link is lost during an alarm condition, location data or dead reckoning raw data is buffered until the cell link is reestablished. At that point, the GPS location data or average speed and direction dead reckoning data is not continuously transformed into a cell phone signal and transmitted, but rather, is stored and sent to the base monitoring station through the cell phone link periodically based upon the speed of the vehicle. In particular, the frequency of the remote unit transmissions is increases as the vehicle's speed increases. Hence, the remote unit preferably does not continuously transform location data or average speed and direction data into a cellular signal. By operating in this fashion, the base station has an opportunity to send command and control signals to remote unit 300 to control the operation of remote unit 300.

GPS receiver 305 (FIG. 3) automatically generates GPS satellite data signals that are provided to the microprocessor 312. When a event sensor signal is detected by the microprocessor, the microprocessor transmits a signal via the module 320 to the base monitoring station indicating that an event sensor signal has been generated by remote unit 300. The base monitoring station then generates a polling signal to poll the microprocessor to send the current location information. The microprocessor then sends the latest time stamped location data to the base monitoring station via the cell phone link. The time stamped location data is in the possession of the microprocessor and the microprocessor simply sends that data to the base monitoring station in response to a polling signal. In other words, there is no request made by the microprocessor to the GPS receiver 305 to request location data.

As described above, a mercury switch, a magnetic heading sensor, a speed reading from the vehicle computer or other devices may sense the movement of the vehicle which causes the microprocessor to send GPS location information or average speed and direction information from remote unit 300 to the base monitoring station. The base monitoring station then calculates whether remote unit 300 has moved a predetermined distance and starts a tracking sequence by sending a signal to remote unit 300 to continue to send location information from remote unit 300 to the base monitoring station.

There are two ways to disarm the remote unit. The first way is to use the key fob to send a signal to the key fob receiver 335 (FIG. 3) to generate a disarm signal that is applied to the microprocessor. The second way to disarm the remote unit is by contacting the asset's owner. The base unit makes calls to a contact list. The contact can then indicate whether the asset has been stolen.

After the vehicle has been parked and the key fob has armed the alarm, a call is made in response to an output by one of the sensors in sensor 330 (FIG. 3). The initial position upon detecting a sensor output is transmitted from remote unit 300 to the base unit. Location information is then periodically sent to the base station that remote unit 300 has traveled a certain distance. In the system of the present invention, the base unit, again, determines whether the remote unit has moved a predetermined distance.

Upon receiving a polling signal from the base station, the remote unit sends a time stamped location signals to the base station. If the cell connection is not available, the remote unit will store the time stamped location signals until a signal is available. Alternatively, the remote unit can be configured to monitor the position of a vehicle. In that instance, a download occurs when the memory capacity of the remote unit reaches a certain level. In other words, times and location stamps are stored in the remote unit and then transferred as a download to the base station based upon when the memory reaches a certain level of used capacity. The rate at which the time/position data is recorded is a conditional rate that is based upon several factors. For example, if the vehicle is still, the time position stamps may be recorded once an hour or just once when the vehicle is first located in that position. However, when the vehicle is moved, the rate of recording time location stamps may be substantially increased, such as every 10 seconds or every minute dependent upon the speed of the vehicle.

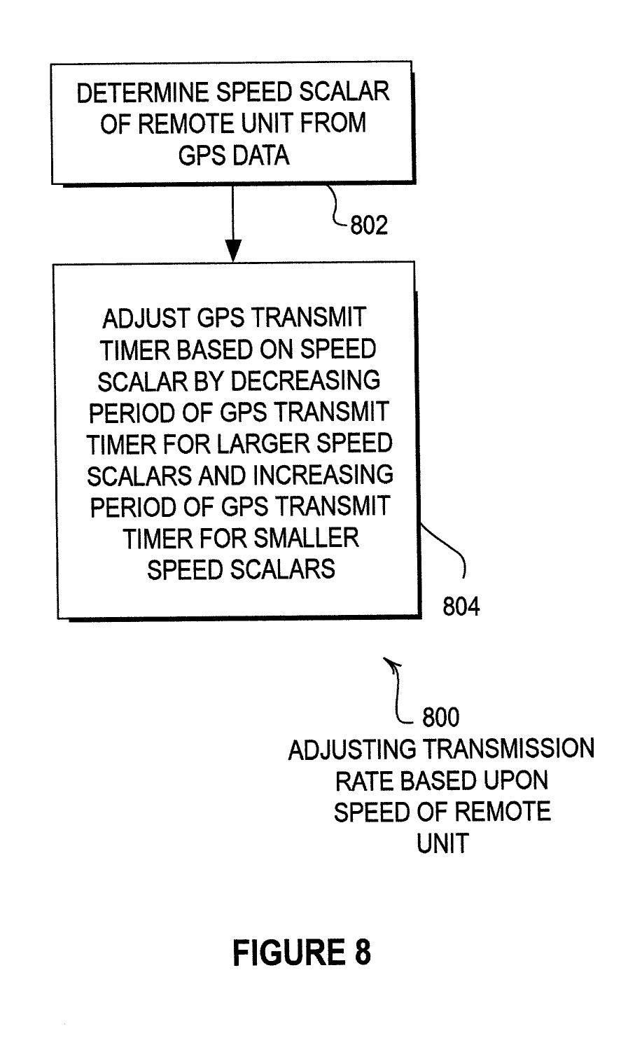

FIG. 8 illustrates the steps 800 that may be performed to adjust the transmission rate of the remote unit based upon the speed of the remote unit. At step 802, the microprocessor 312 determines the speed scaler of the remote unit from the GPS data. The GPS data provides information relating to the speed of the unit which is extracted from the GPS data by the microprocessor 312. The microprocessor 312, at step 804, then adjusts the GPS transmission timer referred to at step 699 (FIG. 6) by decreasing the period of the GPS transmission timer for larger speed scalers, and increasing the period of the GPS timer for smaller speed scalers. In other words, to accurately track the remote unit, it may be advantageous to send time stamped location data more frequently when the remote unit is moving faster. However, if the remote unit is stopped or moving very slowly, it is not necessary to transmit these time stamped GPS location data very frequently. In this manner, the amount of data transmitted can be substantially reduced without jeopardizing the accuracy of the tracking information.

Another aspect of the present invention is to consider the quality of the communications signal. When data is sent through a RF link, the quality of data signal ranges between good and poor over periods of time based upon changes in location of the remote unit, atmospheric conditions, etc. The ability to tolerate those quality changes results from the ability to change the baud rate or data transmission rate of the data signal based upon the data signal strength. If the baud rate or data transmission rate is increased, less noise on the communication channel can be tolerated. Therefore, the remote unit of the present invention utilizes a signal strength indicator 308 (corresponding to the signal to noise ratio in dBs) that forms a portion of the cellular radio module 320 (FIG. 3) to provide a signal strength indicator signal that indicates the quality of the connection. The signal strength indicator signal is provided to microprocessor 312 over lead 309. The microprocessor 312 receives the signal strength indicator signal 309 and generates a control signal 311 that modifies the baud rate or data transmission rate of the cellular radio module. If a very strong strength indicator signal is received by the microprocessor 312, a control signal 311 is generated that allows the cellular radio module 320 to transmit at its maximum baud rate or data transmission rate. As the signal strength falls off, the microprocessor 312 generates a control signal 311 to reduce the baud rate or data transmission rate correspondingly.

To compensate for the varied signal strength described above, the preferred implementation of this method is that the remote unit sends data in predetermined blocks. First, the remote unit samples the signal strength prior to sending the data block. A baud rate that corresponds to that signal strength is determined. The data block is then sent at that baud rate. This is repeated for each data block transmission sent from the remote unit.

The base station may have a separate modem for each baud rate of the remote unit. When a data block is received from the remote unit, each modem processes that block. The base station then determines which modem is providing proper data. Alternatively, the base unit can have a modem that will lock onto the frequency of the data block signal. This can be accomplished by sending a preamble code with the data block so that the base station samples and determines which baud rate is used.

The present invention uses the clock signal from the GPS satellites to synchronize the remote unit and the base unit. In more detail, the base unit can use the same GPS components that the remote unit uses. Therefore, the clock signals that the remote unit and the base unit respectively receive are within a close tolerance of each other. This close tolerance is much less in magnitude than the amount of time required to communicate between the remote and base units. Therefore, the window or time required for communication between the remote and base units can have tighter tolerances. This is especially beneficial when many remote devices can communicate with the base unit. One implementation of the present invention provides for a communication cycle where each of the remote units has respective time slots that form a sequence when combined. At the end of that sequence a time slot for the base station can reserved. Using the clock synchronization described above will allow for a cycle with a tighter tolerance. Hence less time is required for the cycle. This feature is particularly advantageous for a system that tracks a large number of assets. With the tighter tolerances, each communication cycle takes less time. As a result, information from each asset can be obtained on a real-time basis. This is more fully disclosed in U.S. patent application Ser. No. 09/835,893 filed Apr. 16, 2001 entitled “Data Communications Synchronization Using GPS Receiving” which is specifically incorporated herein by reference for all that it discloses and teaches.

A further feature of the present invention is reduced-data transmission. To illustrate, information is transmitted from the remote unit to the base unit. The information can contain data about the specific remote unit, such as an identifier, programmed parameters of that transmitting remote unit, longitude, latitude, altitude, time of day etc. To track an asset for a certain amount of time, that information must be sent periodically. However, in order to reduce the amount of air time required and increase the amount of pertinent information that can be transmitted over short intervals, the information that never changes is transmitted only once with the other information that changes. To illustrate, an asset stores the information in memory for a certain amount of time. When that information is to be transmitted to the base unit, information that did not change over that time is transmitted only once. Thus, transmission time will not be wasted transmitting information that is redundant. More generally, information will be transmitted if it is not redundant.

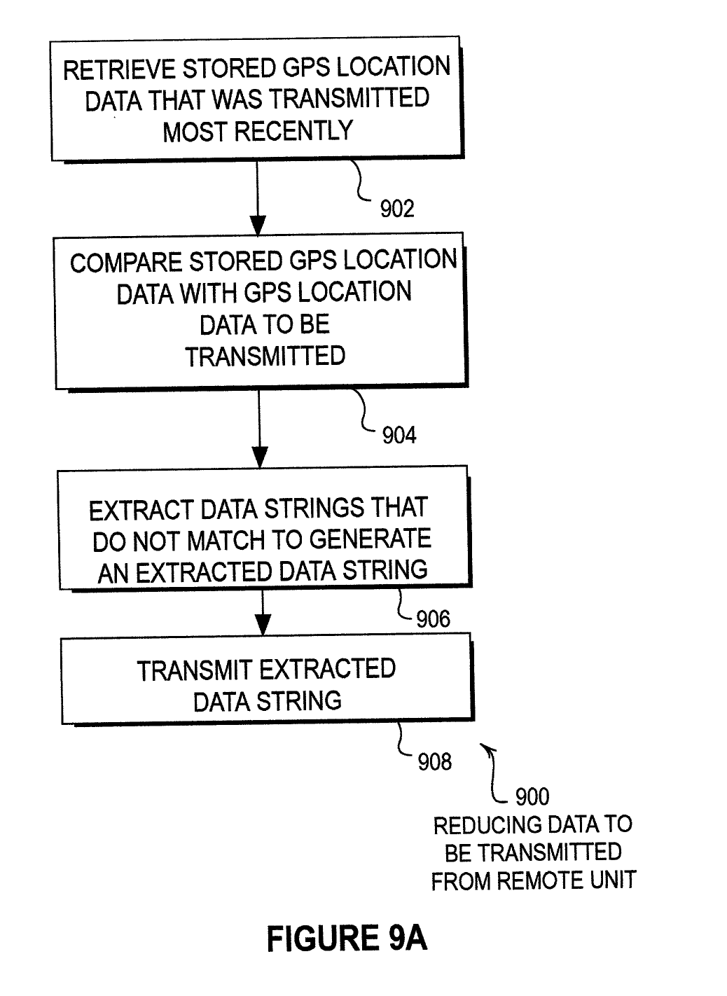

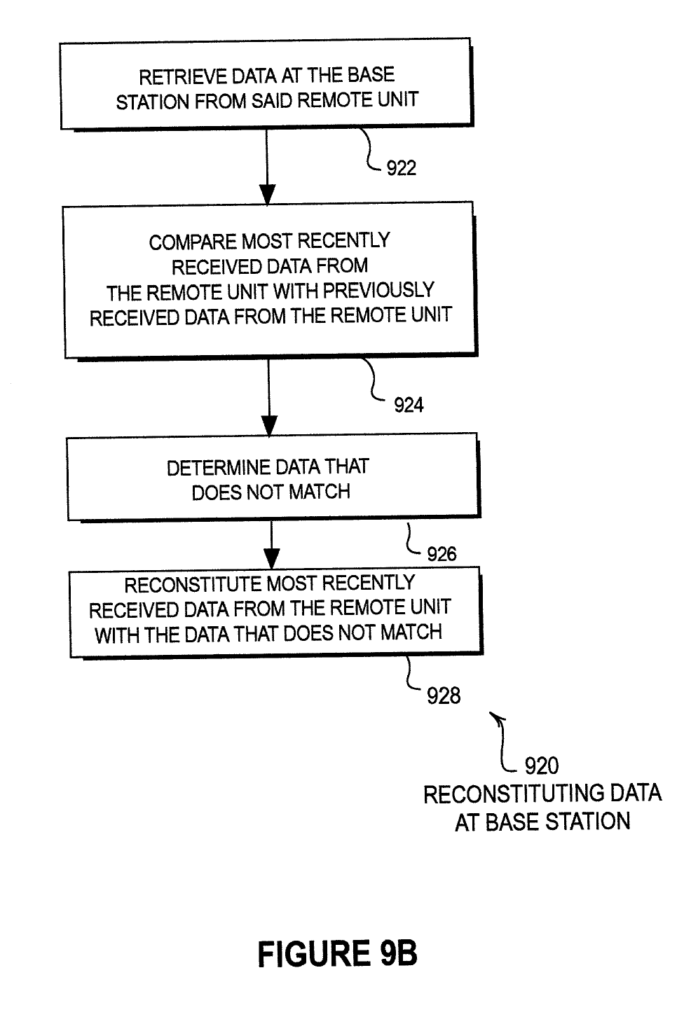

To further illustrate, location information may consist of longitude information such as 117 degrees, 35 minutes and 15.285 seconds. Within the time between transmissions of location data, the only portion of this information that changes may be the seconds. Thus, only the “seconds” information needs to be transmitted. However, to reduce the amount of time spent by the remote unit in determining what has changed, the present invention can be programmed to transmit all the information or a subset when only one value changes. The time is not provided since the base station logs it in when it receives the information from the remote unit. The base unit can then take the updated information and calculate new values for speed, direction, etc. One way of reducing the amount of transmitted data can be performed by the microprocessor 312 of the remote unit. As shown in FIG. 9A, steps 900 illustrate the steps that may be performed by the microprocessor 312 as an example of one method of reducing the amount of data that is transmitted. At step 902, the microprocessor 312 retrieves the stored GPS location data that was most recently transmitted. In other words, the GPS location data that was last transmitted is retrieved from storage by microprocessor 312. At step 904, this stored last GPS location data is compared with location data that is going to be transmitted in the next transmission period. At step 906, microprocessor 312 extracts the data strings from the data that is going to be transmitted that matches the data strings of the data that has been transmitted to generate an extracted data string. At step 908, the microprocessor 312 then provides the extracted data strings to modem 315 which are transmitted by the cellular radio module 320. In this fashion, none of the redundant data is transmitted which greatly reduces the amount of data that is being transmitted by the remote unit. This greatly increases the rate at which data can be transmitted by the remote unit and received by the base station.

The base station receives the extracted data string and can then reconstitute the data by extracting the information that has been stored in the last data transmission or a previous data transmission. Of course, flags can be transmitted to indicate the type of data that has not been sent such as the degrees and minutes data. This will then aid the base station in reconstituting the entire location data set.

FIG. 9B illustrates the steps 920 that may be performed by a processor in the base station for reconstituting data at the base station. At step 922, data is received by the base station from the remote unit. This data is the extracted data stream that does not include redundant data. At step 924, the processor in the base station compares the most recently received data from the remote unit with previously received data from the remote unit. At step 926, the processor in the base station determines which data does not match as a result of the comparison. In other words, previously received data that does not match data from the most recently received data is determined. At step 928, the most recently received data is then reconstituted using data that does not match in the comparison. Of course, the data that does not match includes extended portions of the data stream that may include degrees and minutes type of data.

Another feature of the present invention is that is saves battery power. For example, a vehicle is parked. Remote unit 300 draws a certain amount of current even when it is waiting to receive information from the base station. That current is being provided by the vehicle's battery. To minimize that current draw, the remote unit components can be shut down and turned on at predetermined times of the day. The base station, programmed with those predetermined times, knows when to contact the remote unit. Furthermore, the power to microprocessor 312 and GPS receiver 305 can be cycled at predetermined time intervals. During those cycles, the remote unit can perform administrative tasks, receive GPS data and store that data, or communicate with the base. In particular, the remote unit can receive the GPS information for tracking purposes and relay that information to the base station during those cycles. In this way the asset can be tracked while conserving power.

Auxiliary input 345 and output 350 are general input/output ports that are used for external device control or receipt of external events. Input 345 and output 350 can be used to couple microprocessor to devices that either provide a single signal (input) or are controlled by a single signal (output). For example, input 345 can be connected to buttons that when pressed provide a signal to microprocessor 312. Output 350 can be connected to devices that respond to a signal from microprocessor 312. In that case, microprocessor 312 can control, e.g. turn on and off, certain devices associated with the asset. If the asset is a vehicle, microprocessor 312 can control the horn, lights, audio system, etc. In addition, base station can control those devices using output 350.

Remote unit 300 can also have a microphone and a speaker coupled to module 320 through leads 324, 326. To activate this feature, a signal can be provided to microprocessor 312 through input 345 or interface 340. Microprocessor 312 deactivates the communication path through modem 315 to module 320 and activates module 320 to interface with the microphone and speaker. Without more, GPS information would not be provided to the base station with this feature active.

To overcome that, the remote unit can turn off the microphone/speaker interface for a fraction of a period of time. Then, the GPS information can be transmitted to the base station through modem 315. After that information is transmitted, the microphone/speaker interface can be activated. This mode of operation may be inadequate if better audio transmission is desired. As an alternative, the audio information from the microphone over lead 324 can be provided to microprocessor 312. Microprocessor 312 can then combine the audio signal from the microphone with modulated GPS information. This combined signal can then be provided to module 320 for transmission to the base station. Upon receipt, the base station can extract the modulated GPS information from the combined signal. The modulated GPS information is preferably a very slow frequency, about 250 Hz. This subaudible signal transfers data to the base station as it is superimposed over the audio from the microphone. This allows the transmission of a voice conversation and GPS location data over the same channel at the same time.

An additional feature of the present invention is the provision of video data from the remote unit to the base station. Receiving timing information from the GPS satellites provides synchronized clocks at the remote unit and base station. Thus, a window with a predetermined duration can be programmed into both the remote unit and the base station. Sync pulses that are generated from the GPS information would define the window. In that window the remote unit will send the video data. That transmission will start with an embedded sync code that enables the base station to determine the start of the video data. The base station will start to “look” for that sync code at the beginning sync pulse of the window. At the end of the video data is another sync code so that the base station will know the video data has ended. In addition, the present invention eliminates the use of error correction with the video data transmission. This allows for a shorter duration of the window. In other words, the duration between the sync pulses of the window is preferably the time necessary to transmit one image plus the sync codes.

The present invention also provides the function that the base station can change the programming of the remote unit. In this case, the base unit query the remote unit to send the remote unit's programmed parameters. The remote unit would then send those parameters. The base unit would determine which, if any, parameters should be changed. If a change is desired or necessary, the remote unit will send data to the remote unit that includes the information to reprogram itself according to the sent data. It is preferred that the remote unit acknowledges receipt of the data from the base station and that the reprogramming was completed. In this manner, field servicing of the remote unit, say to update some parameter, can be minimized or eliminated.

Numerous variations and modifications of the embodiments described above may be effected without departing from the spirit and scope of the novel features of the invention. No limitations with respect to the specific system illustrated herein are intended or should be inferred. It is, of course, intended to cover by the appended claims all such modifications as fall within the scope of the claims.

What is claimed is:

1. A method of generating an alarm condition in a telematics system comprising:
transmitting location information from a remote unit to a base station after said remote unit has been armed and said remote unit has detected an event;
determining if said remote unit has moved beyond a preprogrammed perimeter;
generating an alarm condition whenever said remote unit has moved beyond said perimeter.

2. The method of claim 1 further comprising allowing a user to establish said preprogrammed perimeter.

3. The method of claim 1 wherein said detection of an event comprises the detection of a magnetic sensor change.

4. The method of claim 1 wherein said detection of an event comprises detecting a signal indicating the activation of the ignition of a vehicle to which said remote unit is connected.

5. The method of claim 1 wherein said detection of an event comprises detecting a signal from a mercury switch indicating that the remote unit has been moved.

6. The method of claim 1 wherein said detection of an event comprises detecting a speed signal from said remote unit.

7. The method of claim 1 wherein said detection of an event comprises detection of a signal indicating that a check-in timer has expired.

8. A telematics system that generates an alarm condition whenever a remote unit has moved beyond a predetermined perimeter after said remote unit has been armed comprising:
event sensors located in said remote unit for detecting an event and generating an event signal;
a microprocessor disposed in said remote unit that detects said event signal and generates a control signal to cause said remote unit to transmit location data to a base station;
a processor disposed in said base station that determines if said remote unit has been moved beyond a predetermined perimeter and generates an alarm signal.

9. The telematics system of claim 8 wherein said event sensor is a magnetic sensor.

10. The telematics system of claim 8 wherein said event sensor is an ignition sensor.

11. The telematics system of claim 8 wherein said event sensor is a mercury switch.

12. The telematics system of claim 8 wherein said event sensor is a speed sensor.

13. The telematics system of claim 8 wherein said event sensor is a timer sensor.

14. A method of adjusting the transmission frequency period of a remote unit in a telematics system comprising:
determining the speed of movement of said remote unit;
adjusting said transmission frequency period in response to said speed of movement of said remote unit so that said period is increased whenever said remote unit is moving at a lower speed and decreased whenever said remote unit is moving at a higher speed.

15. A telematics system that adjusts the transmission frequency period of a remote unit to minimize the amount of location data transmitted from said remote unit to a base station comprising:
a microprocessor that determines the speed of movement of said remote unit and adjusts said transmission frequency period of said remote unit based upon said speed of movement of said remote unit;
a transmitter that transmits data to said base station at a rate based upon said transmission frequency period.

16. A method of decreasing the amount of data that is transmitted by a remote unit in a telematics device comprising:
comparing data that has been previously transmitted by said remote unit with data to be transmitted by said remote unit;
extracting data strings from said data to be transmitted that does not match data strings of said data that has previously been transmitted to generate extracted data strings;
transmitting said extracted data strings.

17. The method of claim 16 further comprising:
obtaining data strings at said base station that have been previously transmitted;
comparing said previously transmitted data strings with data strings that are last received by said base station;
reconstituting said data strings last received by said base station with data that does not match previously transmitted data.

18. A telematics system that decreases the amount of data that is transmitted by a remote unit comprising:
a microprocessor disposed in said remote unit that compares data that has been previously transmitted by said remote unit with data to be transmitted by said remote unit and extracts data strings that do not match;
a transmitter that transmits said data strings to a base station.

19. A telematics system that decreases the amount of data that is transmitted by a remote unit comprising:
a microprocessor disposed in said remote unit that compares data that has been previously transmitted by said remote unit with data to be transmitted by said remote unit and extracts data strings that do not match;
a transmitter that transmits said data strings to a base station.

20. A method of adjusting the data transmission rate of a cellular radio module in a remote unit of a telematics device and maintaining quality data transmissions comprising;
detecting signal strength of a communication link between said cellular radio module and a base station;
adjusting said data transmission rate of said cellular radio module based upon said signal strength.

21. A remote unit of a telematics system that is capable of adjusting the data transmission rate of data transmissions from a cellular radio module comprising:
a signal strength detector that generates a signal strength indicator signal that indicates the strength of a communications link between said cellular radio module and a base station;
a microprocessor connected to said signal strength detector that determines said strength of said communications link and generates a control signal that is applied to said cellular radio module to control said data transmission rate.

22. A method of prioritizing the transmission data from a remote unit to a base station in a telematics device comprising:
determining when a communication link is broken between said remote unit and said base station;
storing location data while said communication link is broken;
determining when said communication link has been re-established;
transmitting current location data prior to stored location data.

23. A telematics system that prioritizes the transmission of location data comprising:
a cellular radio module that establishes a communication link between a remote unit and a base station to transmit said location from said remote unit to said base station;
a microprocessor disposed in said remote unit that detects whenever said communication link is broken and stores location data, and provides current location data to said cellular radio module prior to stored location data whenever said communication link is re-established.

24. A method of providing dead reckoning location information in a telematics device whenever a communication link between a remote unit and a base station is lost comprising:
generating raw direction and speed data at a remote unit of said telematics device and GPS location data;
transmitting said GPS location data and said raw direction and speed data from said remote unit to a base station;
calculating location information at said base station using said GPS location data and said raw direction and speed data using dead reckoning techniques.

25. A telematics system that is capable of generating dead reckoning data comprising:
a compass disposed in a remote unit that generates direction data;
a microprocessor disposed in said remote unit that generates speed data and GPS location data;
a transmitter disposed in said remote unit that transmits said direction data, said speed data and said GPS location data;
a receiver disposed in a base station that receives said direction data, said speed data and said GPS location data;
a processor disposed in said base station that calculates location information using dead reckoning techniques.

26. A method of providing dual antennas in a telematics device that minimize space requirements and provide isolation comprising:
placing a GPS antenna on a first portion of a substrate having a first ground plane that is isolated from other ground planes in said telematics device;
placing a cellular phone antenna on a second portion of said substrate having a second ground plane that is isolated from other ground planes in said telematics device and from said first ground plane;
placing an isolation fence between said GPS antenna and said cellular phone antenna to isolate said GPS antenna and said cellular phone antenna.

27. A antenna system for a telematics device comprising:
a GPS antenna disposed on a first portion of a substrate having a first ground plane that is isolated from other grounds in said telematics device;
a cellular phone antenna disposed on a second portion of said substrate having a second ground plane that isolated from said first ground plane and other grounds in said telematics device;
an isolation fence disposed between said GPS antenna and said cellular phone antenna in said telematics device that isolate said GPS antenna and said cellular phone antenna.

28. The antenna system of claim 27 wherein said isolation fence is coupled to a ground plane of said substrate.

29. The antenna system of claim 27 wherein said isolation fence is coupled to a conductive housing of said telematics device.

30. A device for monitoring voltage levels of an external power source connected to a telematics remote unit comprising:
a monitor voltage circuit connected to said external power source;
a logic device connected to said monitor voltage circuit that detects the duration and amplitude of voltage drops of said power source and generates an alarm signal whenever said duration an amplitude of said voltage drop exceeds a predetermined threshold.

31. A method of determining if external power has been lost to a telematics remote unit comprising:
monitoring voltage levels of said external power with a logic device;
detecting duration and amplitude of voltage drops of said voltage level;
generating an alarm signal whenever said duration and amplitude of said voltage drops exceed a predetermined threshold.

32. The method of claim 31 further comprising:
automatically applying power from backup batteries located in said telematics remote unit upon generation of said alarm signal.

33. A self contained telematics remote tracking unit that includes anti-defeat countermeasure features that reduce the ability to disable said telematics remote tracking unit comprising:
internal backup batteries located in said telematics remote tracking unit to provide power to said telematics remote tracking unit to wherever external power is lost;
flash suppression circuitry in said telematics remote tracking unit and in series with said external power;
multiple isolated ground planes connected to separate circuits in said telematics remote tracking unit;
a housing constructed of a conductive polymer that protects internal circuitry from electrical impulses;
antennas that are disposed internally in said telematics remote tracking unit adjacent windows in said housing that are non-conductive and transmit electromagnetic waves.

34. A method of reducing the ability to disable a telematics remote tracking unit by including anti-defeat countermeasure features comprising:
providing internal backup batteries in said telematics remote tracking unit to provide power whenever external power is lost;
providing flash suppression circuitry in series with said external power;
providing multiple isolated ground planes for separate circuits in said telematics remote tracking unit;
providing a conductive polymer housing that protects telematics remote tracking unit circuitry from electrical and electromagnetic impulses;
providing antennas that are disposed internally within said telematics remote tracking unit adjacent windows in said housing that are non-conductive and transmit electromagnetic waves.
